(19) United States
(12) Patent Application Publication
(10) Pub. No.: US 2016/0104363 A1
(43) Pub. Date: Apr. 14, 2016

(54) REMOTE MONITORING OF A PERIODICALLY UNOCCUPIED PROPERTY USING A WIRELESSLY ENABLED TELEMETRY DEVICE WITH INTEGRATED SENSORS

(71) Applicant: HouseSetter, LLC., Grosse Pointe Farms, MI (US)

(72) Inventors: Walter A. Dorfstatter, Northville, MI (US); Chester A. Huber, Grosse Pointe Farms, MI (US)

(21) Appl. No.: 14/880,985

(22) Filed: Oct. 12, 2015

Related U.S. Application Data
(60) Provisional application No. 62/063,127, filed on Oct. 13, 2014.
(60) Provisional application No. 62/240,385, filed on Oct. 12, 2015.

(51) Int. Cl. G08B 21/18; G01D 9/02; H04L 12/58; H04N 7/18

(52) U.S. Cl. CPC G08B 21/182; H04N 7/18; G01D 9/02; H04L 51/10

(57) ABSTRACT

The service of “keeping an eye” on a vacant property in a simple, low-cost and reliable manner required extreme focus in selecting high-value parameters to be monitored, and the creation of a unique, proprietary, and highly interdependent product and technology architecture to effectively and efficiently deliver the service is contemplated.

### CROSS-REFERENCE TO RELATED APPLICATIONS

This application claims the benefit of U.S. provisional Application No. 62/063,127 filed Oct. 13, 2014 and U.S. provisional Application No. 62/240,385 filed Oct. 12, 2015, the disclosures and benefits of which are incorporated in their entireties by reference herein.

### TECHNICAL FIELD

The present invention relates to a system that achieves very low cost, a simple to operate Device for remotely monitoring residential home environments. One purpose is to fulfill the job of “keep an eye on my house” that faces many individuals who own and periodically occupy seasonal use properties. The Device is capable of sensing temperature, humidity, AC power, and internal battery level as well as capturing images on a periodic or on-demand basis. The data and images will be posted to a publicly or privately hosted system.

### BACKGROUND

Millions of Americans own multiple properties for many reasons including seasonal use or vacation getaways, and they all share the same problem of not being able to be in two places at once. This results in properties being vacant for extended periods of time, and a concern that comes from not knowing if everything is alright while they're away. Many choose to hope that nothing will go wrong due to the existing home automation/security systems, DIY system or physical inspection alternatives that are either complicated, costly or both. A need exits for a simple, low cost and reliable approach to home monitoring that allows homeowners to maintain contact with their vacant property, periodically receive status updates when things are fine, and immediately be notified when they're not—allowing them to take action to prevent small problems from becoming big ones.

### BRIEF DESCRIPTION OF THE DRAWINGS

FIGS. 1a-1g illustrate the self-contained device that houses the camera, sensors in a unique representation of a dog

FIG. 2 illustrates the system overview

FIG. 3 Illustrates the device block diagram

FIG. 4 illustrates the various states of the device

FIG. 5 illustrates the flowchart monitoring

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

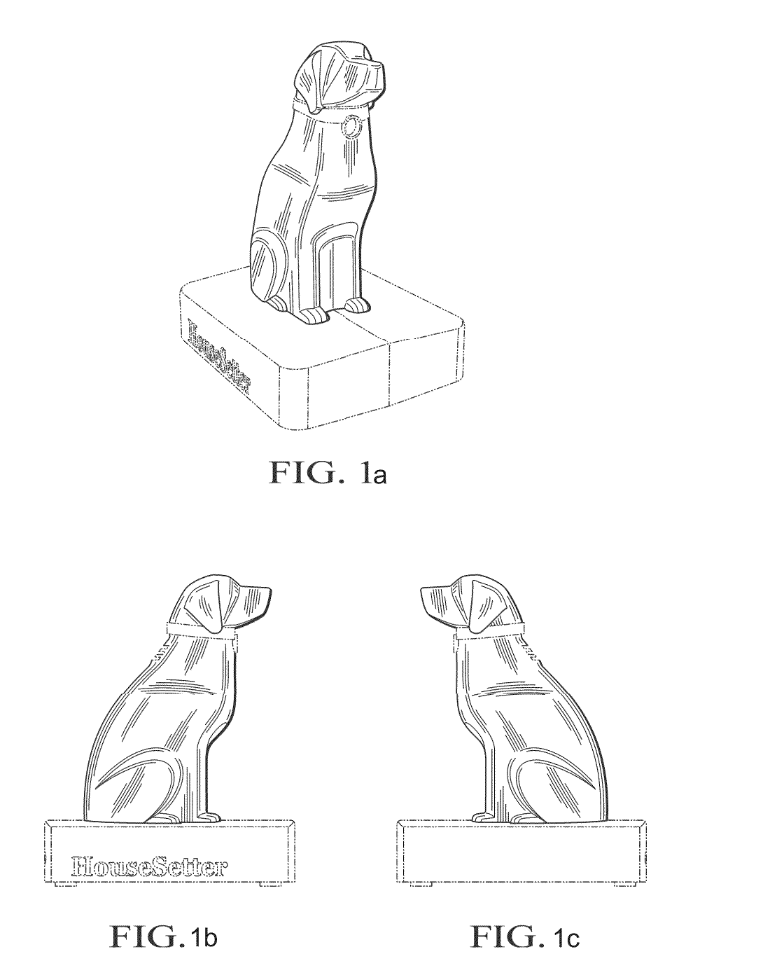

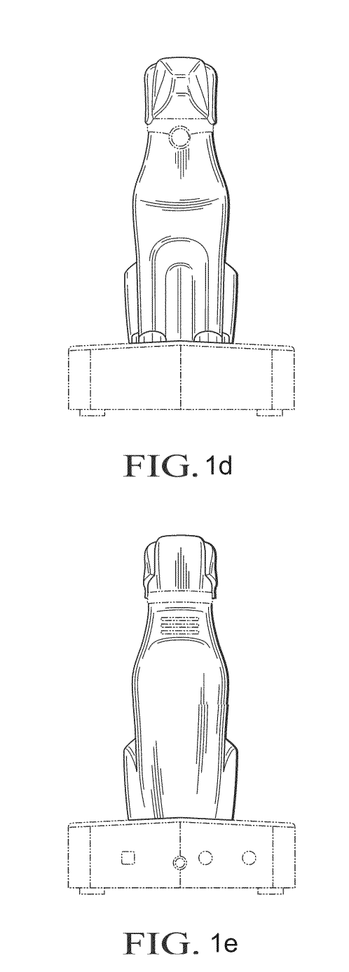

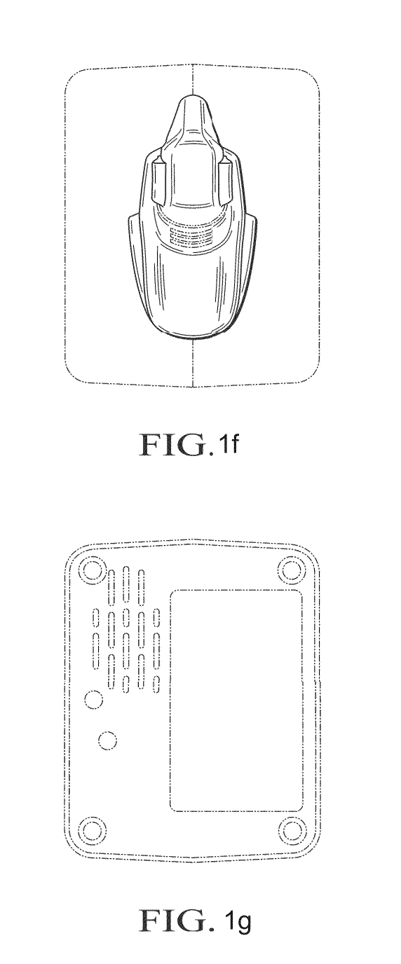

The inventor's home monitoring service is based on a machine-to-machine (M to M) architecture where a wirelessly enabled hardware device (Sherlock—FIG. 1) gathers situational awareness data and transmits it via a secure cellular data network connection to a cloud based IT back-office which interprets and processes the data for incorporation into subscriber reports and alerts. One intended target market for the service are individuals that need to “keep an eye” on a seasonally or occasionally unoccupied property and have found other alternatives too expensive, inconvenient, complicated, unreliable or some combination of the four.

One aspect of the present invention contemplates servicing the job of “keeping an eye” on a vacant property in a simple, low-cost and reliable manner required extreme focus in selecting high-value parameters to be monitored, and the creation of a unique, proprietary, and highly interdependent product and technology architecture to effectively and efficiently deliver the service. Monitoring vacant properties also pose additional design challenges involving the likelihood of many being located in rural and often remote areas with limited RF coverage and less reliable AC power, the fact that they may be left unoccupied and otherwise unattended for months at a time, and they can be hundreds if not thousands of miles removed from their owners and not practically accessible for maintenance or resets.

To address these requirements, Sherlock's key design elements can be broken down into five areas:
1. Monitoring parameter choice
2. System integration
3. Wireless data transport
4. Configurability and remote software management
5. Mechanical design

Monitoring Parameter Choice

In order to meet the key requirements of simplicity, cost and reliability, the range of data gathered has been initially narrowed to provide situational awareness on the conditions within the property. These include monitoring its ambient temperature and relative humidity (at Sherlock's location), sensing an AC power failure (at the outlet Sherlock is plugged into), and providing the capability to capture and send a static image. While executing this focused set of monitoring parameters provides the foundation for the platform, extensions will likely be pursued through near-field wireless communications between Sherlock acting as the “hub” and a range of additional sensors. Among others, these could extend the physical monitoring space (temperature & humidity sensors for different rooms or floors within the same property), sense power outages affecting the operation of other important appliances or devices, or add new monitoring modalities (C02 or water sensors, etc.).

System Integration

One aspect of the present invention contemplates delivering reliability and customer simplicity is a highly interdependent hardware and software operating system and embedded active cellular modem that forms the basis of Sherlock's design. Integrated temperature and humidity sensors continuously feed readings to a processor which log their values and compare them against pre-set, customer configurable alert thresholds to determine real-time status, triggering push alerts as required. Additionally, unique device software continuously monitors the voltage of outlet that it's plugged into and will both seamlessly transition to its integrated back-up battery and trigger a push alert upon sensing a power outage. Beyond alert triggered messaging, the design also incorporates a number of additional interactive capabilities including:
A “heartbeat” feature which periodically communicates with HouseSetter's IT back-office to confirm service connectivity and operation
Recurring normal status reporting which incorporates real-time data readings, the results of device self-diagnostic testing, and an optional near real-time image captured by the device.
The ability of subscriber to trigger an On Demand report from the device at any time including all of the information listed above.

The device also integrates a single power button and speaker (playing embedded audio files to indicate actions or status changes) as its primary user interface, supplemented with a secure login customer website Subscriber Control Panel to manage device alert settings and messaging preferences.

Wireless Data Transport

A foundational element of the cost, simplicity and reliability deliverables is the incorporation of an embedded, secure and interdependently managed cellular data network connection between the device and the HouseSetter back-office. This connection enables Sherlock to be completely pre-provisioned at the factory and immediately ready for plug-and-play service when he's received by a customer. Additionally, Sherlock's connectivity (RF performance) has been enhanced through the unique physical implementation of a proprietary antennae design.

Configurability and Remote Software Management

Sherlock's design incorporates a significant range of software configurable features and settings, all of which designed to be remotely accessed, updated and managed via his cellular data connection to HouseSetter's back-office service platform. His core, proprietary operating software is completely updatable, allowing for the development and deployment of new services to previously sold and provisioned devices.

HouseSetter remotely programmable settings include camera parameters, temperature and humidity offset and hysteresis factors, automatic event trigger timing, device volume control and prompt triggers, cellular network provisioning and service package management, among others. Remotely configurable subscriber customization options include enabling or disabling temperature and humidity alerts, and setting high and low thresholds for alert triggers.

Mechanical Design

Sherlock's unique mechanical design incorporates the brand queue reinforcement of a friendly, faithful, loyal and protective dog standing watch of his owner's property with the functional requirements of packaging the technology for effective service delivery. The pedestal that the dog stands on allows for a circuit board design that radiates heat off of the top surface, providing the support for a chimney effect convective air flow that travels up the hollow dog torso, exiting through vent slots located at the back of the dog's neck. This causes fresh air to be drawn in though vent slots located on the underside of the pedestal's base, and through an isolated chamber which houses the temperature and humidity sensors.

In addition to supporting the updraft, the dog's body's height also allows for the location of the camera module on the dog's collar approximately 5 inches above the base of the pedestal providing for an improved field of view for the camera. This shape and geometry also provides flexibility to route the camera's high-speed data connection in a way that minimizes its negative EMI effects on the cellular antennae. Also the size and shape of the pedestal were designed in support of extremely high antennae performance in low signal strength geographies by allowing the antennae to be located in an unobstructed portion of the housing isolated from other potentially interfering components.

The device design also incorporates a very simple UI, with a single button on/off switch and two multi-color LEDs, one indicating system state (normal operation, off, and operating on back-up battery) and one indicating cellular signal strength (good, marginal and no signal). The physical UI is supplemented with a device embedded speaker that plays pre-recorded prompts triggered by a range of conditions and events.

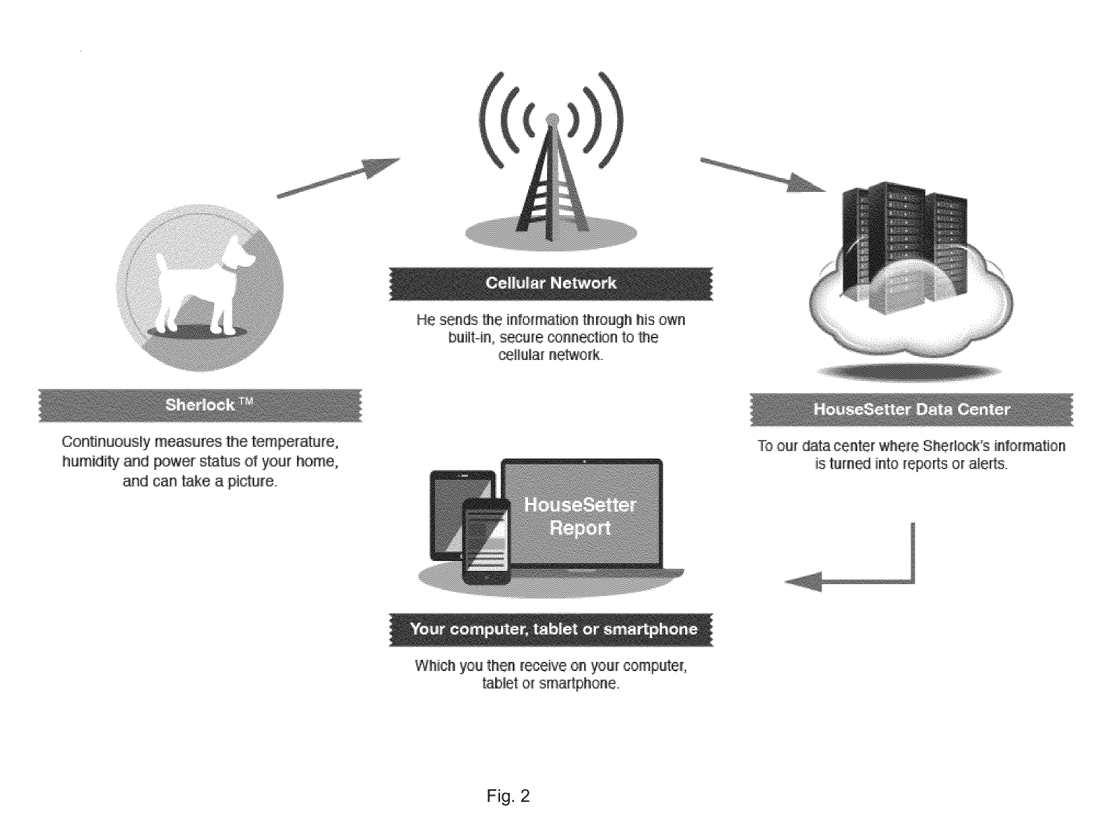

FIG. 2 illustrates how home monitoring services are enabled by a proprietary, interdependent series of building blocks. Together they collect and assess situational awareness data from a vacant property, evaluate and transmit the data over an embedded, secure connection to a cellular data network, interpret and reprocess that data based upon customizable subscriber preferences, and ultimately render them into reports and alerts delivered via email and text messages. The following describes the functions provided by each element in the system's architecture, and how they combine to uniquely achieve the objectives of providing a reliable, low cost and simple method of keeping an eye on a subscriber's vacant property while they're away.

Hardware Device—“Sherlock”

Sherlock is the name of the device that houses all of the technology necessary to gather and transmit the required data necessary for monitoring. It is located within the property to be monitored and contains temperature and humidity sensors, a digital camera, a back-up battery, a digital cellular modem, and the processing power, memory and proprietary operating software necessary to manage the gathering and transmission of the required information. Additionally, it includes a simple, intuitive UI at the device level, consisting of a single power button, LEDs to indicate system state and cellular signal strength, and a speaker, amplifier and embedded audio files to provide real-time feedback on system status and operation.

Mechanical design criteria included housing geometry and component placement to implement a unique antennae system to improve cellular connectivity in low signal strength geographies, and to induce natural convection currents that continuously draws fresh air into the chamber housing the temperature and humidity sensors.

Wireless Data Network

Two-way wireless data transfer for device management and service delivery is accomplished through an integrated and HouseSetter managed and controlled connection to Verizon's extended data network. The interdependent approach allows for devices to be fully provisioned and immediately ready for service anywhere in the United States by simply plugging the device into a standard power outlet and pressing the power button. It also insures a robust and secure connection through the use of a Private Network approach, maintaining complete management control and visibility of the data sent to and received by the device.

When the device is in an active state the cellular connection allows the HouseSetter Data Center access to manage the devices settings, perform device diagnostic scans and software updates, and trigger the device to respond to On Demand service requests. The connection also allows the device to send self-initiated data to the HouseSetter Data center to produce periodic subscriber reports, create triggered alerts, and maintain connectivity visibility to confirm service availability.

HouseSetter Data Center

HouseSetter's data center is the hub responsible for monitoring, controlling and delivering HouseSetter services. It communicates with the device through a proprietary data protocol, and to the customer through a web-based ecommerce and subscriber portal. It integrates customer and device data bases, controlling subscription access, managing subscriber personalization settings, and downloading and maintaining version control of hardware parameters and device software. It analyzes and interprets inbound data from the device, rendering periodic email reports and alert texts and emails according to subscription package requirements and customer established customization settings. It also provides access to the primary subscriber management tool, the Subscriber Control Panel, which allows subscribers to manage all aspects of their account and device customizable features through a unique, password protected web portal.

HouseSetter Reports and Alerts

The ultimate HouseSetter service deliverables are the reports and alerts containing data from the property that they are monitoring. Under normal conditions, HouseSetter will gather data on a regular and predictable cadence, embed it into simple, easy to understand HomeData Report template, and send it to email addresses chosen in advance by the subscriber. The information in the report will include the temperature and humidity measured at the device's location, confirmation that the AC power is on, and the results of a device self-diagnostic check. Also, depending upon the service package, it will include a picture taken at time of the data gathering, generally less than 1 minute before the subscriber's receipt of the email.

If at any time between HomeData Reports an alert is triggered (temperature or humidity readings above or below alert thresholds, or loss of AC power), HouseSetter will immediately send specially formatted alert emails and texts highlighting the problem. Once in an alert condition, the alert messaging timeline will go into effect, resending alert emails and texts hourly for the first six hours and then every six hours for the balance of two days. The timeline will be suspended at any point during the two days if the alert condition is resolved, triggering the sending of all-clear emails and texts. If multiple alerts compound over time (i.e. AC power outage leading to low temperature due to loss of heating), then the newest alert will be added to the messaging and the timeline will reset to the beginning of its six hourly message cadence. In a multiple-alert scenario, all-clear messages will be sent as each condition is resolved, but the overall alert status will remain active until all conditions return to normal status.

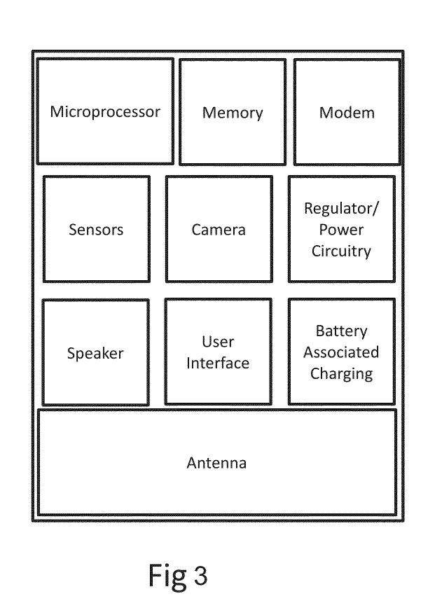

FIG. 3 illustrates a block diagram of the hardware components of the device. The Microprocessor in FIG. 3 controls the operation of the entire device. Software within the internal and external Memory, allows it to manage the state machine, various time (sample, sensor , summary, etc.) frequencies, communication with the server, reading the sensors, interfacing with the camera, monitoring for Alerts, creating the UI with the LEDs and audio prompts, and processing requests from the server. Many of the parameters are configurable from the server.

The Modem provides the wireless connectivity. This enables for both UDP and TCP communication of messages, updates as well as file transfer.

The Sensors provide the environment readings to access alert conditions as well as provide informative data. Types of data include temperature, humidity, AC power, back-up battery voltage, etc.

The camera provides snapshots with various configurations including resolution, compression.

The User Interface, primarily made up of two LEDs (State and Connectivity) the speaker with associated audio circuitry provide audio feedback to enhance the user experience

The Regulator and power circuitry control provide the proper power source for the conditions.

The back-up Battery and associated charging circuitry provide power when there is a loss of primary AC power at home. It is a LiPo battery that will power the device for at least two days under normal circumstances.

The Antenna is a proprietary, PCB based antenna that has been tuned for this PCB. It provides significantly better RF performance than standard cellular phone antennas.

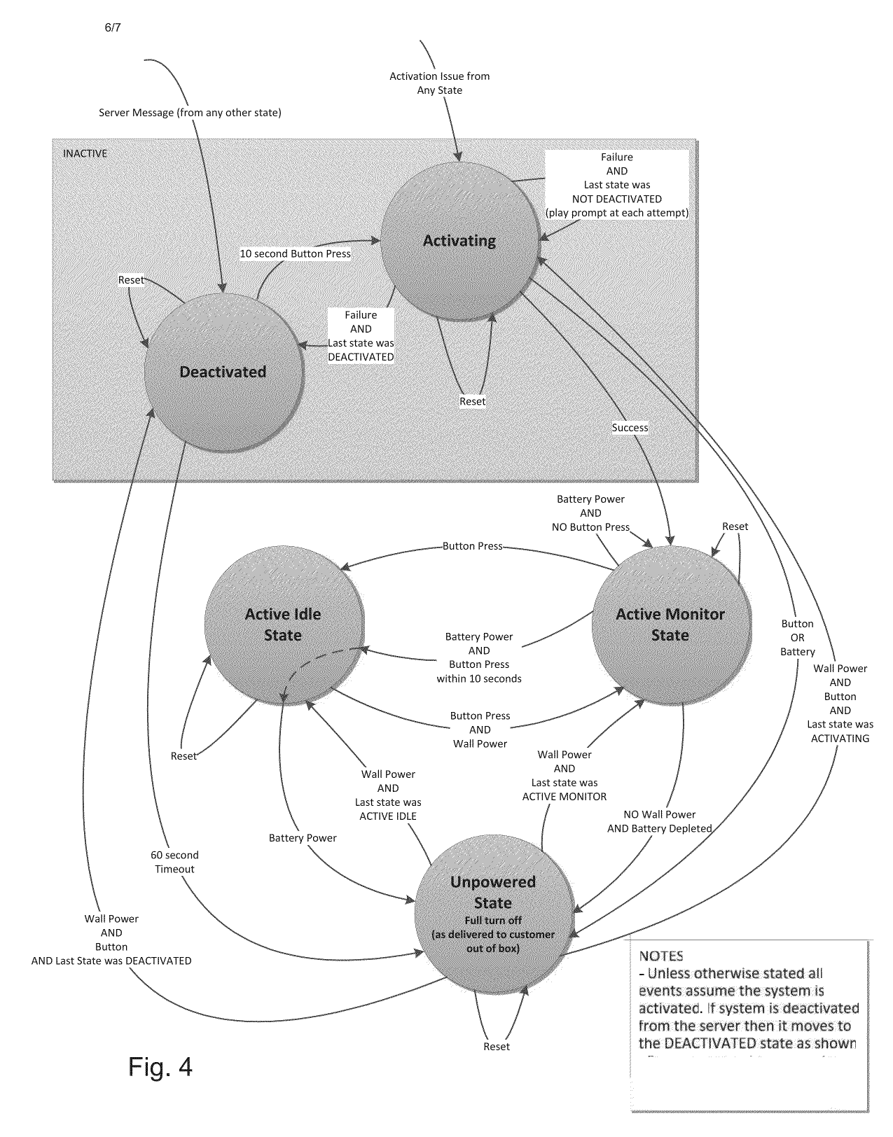

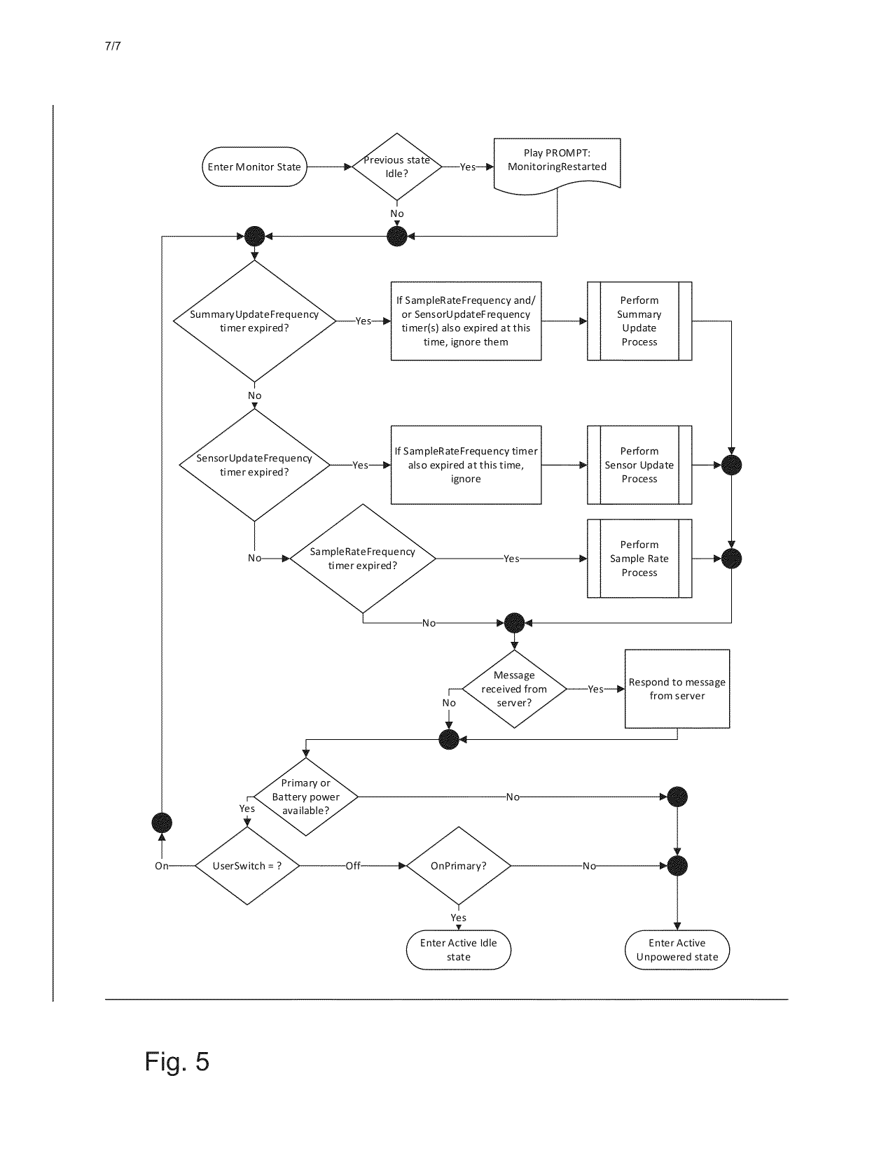

FIG. 4 illustrates the various states of the device. The Activating state is the initial state and handles provisioning of the modem on the network. It processes the OTA registration with the network. Upon successful activation, the state moves to Active Monitor. Active Monitor is the normal state of the device. It actively retrieves environmental data samples at a configurable frequency to determine Alert conditions. It also processes sensor updates at a configurable frequency for sending the heartbeat updates to the server. It processes summary updates at a configurable frequency, with or without a picture for the periodic customer reports to the server. It will respond to any server requests. See FIG. 5 for more detail.

A user button press will transition the device to Active Idle. In Active Idle all the primary frequency based reports to the server are suspended. The back-up battery will charge if appropriate. With loss of primary AC power the device will go to the Unpowered state but store appropriate registers in non-volatile memory for proper power start up.

When AC power is returned to the Unpowered State, the device proceeds through its boot up process and reads non-volatile registers to return to its prior state.

Deactivated is a unique state that only the server can place the device in. In this state the device will no longer register on the network and therefore it is not reachable remotely. In this state, it plays a unique prompt indicating that the device has been deactivated. The customer will need to enroll at the server and then reset the device to reenter Activating. At that point the device will register with the network and begin normal operation if successful.

FIG. 5 shows a flowchart of the Active Monitor state. Block indicates entering Active Monitor state from any other state as depicted in FIG. 4. When entering Active Monitor, Block relates to determining if the previous state was Active Idle. If true, it will play a prompt indicating that Sherlock is On-duty and will send an On-duty Alert. Block checks whether the summary update frequency has expired, if so it will perform the summary update and send the information to the server. Block determines if the sensor update frequency has expired, it will perform the sensor update and send it to the server. Block If the sample frequency has expired it will perform the sample update. Should any of the sample data be above or below predetermined thresholds it will send an alert to the server. Block indicates a check to respond to any messages received from the server. Block determines whether to enter Unpowered state if there is a loss of both AC and battery power. Block xx will monitor the user switch to move to the Idle state or returns back to Block.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for remote monitoring of a periodically unoccupied property using a wirelessly enabled telemetry device with integrated sensors, the method comprising:
gathering environmental data;
taking an image at the time the data is collected; and
presenting this data with the image in a preset periodic or customer determined periodic email.

2. The method of claim 1 further comprising:
adding internal data/status, such as battery charging/storage state, device on/off-duty, diagnostic information, wireless signal strength, location, outstanding alerts; and
presenting this data with the image in a preset periodic or customer determined periodic email to the customer

3. A system for remote monitoring of a periodically unoccupied property using a wirelessly enabled telemetry device with integrated sensors, the system comprising:
a device configured to check environmental data, check against predetermined thresholds to send server alerts, send configurable periodic sensor reading for a heartbeat, and send predetermined summary updates with an image on a periodic basis; and
a server configured to communicate with the device such that it receives alerts, sensor heartbeats, summary data and images, transforming them into email for delivery to the customer.

4. The system of claim 3 further comprising a customer computer/mobile device to receive and interact with such emails.

5. A device for remote monitoring of a periodically unoccupied property using a wirelessly enabled telemetry, the device comprising:
a processor for executing non-transitory computer-readable instructions stored on the device, including controlling operations of the device according to the non-transitory instructions so as to enable the device to manage state machine, various time frequencies, communication with a server, reading sensors, interfacing with a camera, monitoring for alerts, creating a user interface (UI) with LEDs and audio prompts, and processing requests from the server.

6. The device of claim 5 further comprising a modem that provides wireless connectivity and enables both UDP and TCP communication of messages, updates as well as file transfer.

7. The device of claim 6 wherein the sensors provide environment readings to access alert conditions as well as provide informative data, including temperature, humidity, AC power, and back-up battery voltage.

8. The device of claim 7 wherein the camera provides snapshots with various configurations including resolution, compression.

9. The device of claim 8 wherein the UI relies on two LEDs (State and Connectivity) and the speaker with associated audio circuitry to provide audio feedback to enhance the user experience.

10. The device of claim 9 further comprising a regulator and power circuitry control to provide proper power source for wirelessly transmitting telemetry under various conditions.

11. The device of claim 10 further comprising a back-up Battery and associated charging circuitry to provide power when there is a loss of primary AC power at home.

12. The device of claim 11 wherein the Antenna for the Modem is a PCB based antenna that has been tuned for this PCB.
